(19) United States
(12) Patent Application Publication
(10) Pub. No.: US 2016/0350137 A1
(43) Pub. Date: Dec. 1, 2016

(54) GUIDE FILE CREATION PROGRAM

(71) Applicant: SHIMADZU CORPORATION, Kyoto-shi (JP)

(72) Inventor: Takayuki KIHARA, Kyoto-shi (JP)

(73) Assignee: SHIMADZU CORPORATION, Kyoto-shi (JP)

(21) Appl. No.: 15/150,567

(22) Filed: May 10, 2016

(30) Foreign Application Priority Data
May 28, 2015 (JP) 2015-108401

(51) Int. Cl. G06F 9/44; G06F 17/21; G06T 11/60; G06F 17/24; G06F 3/0484

(52) U.S. Cl. CPC G06F 9/4446; G06F 17/241; G06F 3/04845; G06T 11/60; G06F 17/212

(57) ABSTRACT

Provided is a program for helping the creation of a guide file, such as an electronic manual or operation navigator, for guiding an operator who operates a target program while the target program is running. The program makes a computer function as: an operation target for detecting a target of operation performed by a creator operating the target program; a graphic guide displayer for displaying a graphic guide in the vicinity of the target of operation: a text guide displayer for displaying, on the window of the target program, a preset guiding text related to the target of operation and/or an input field for allowing the creator to type in text; a contents storage processor for storing, into a designated storage section, the target of operation, the graphic guide and other contents; and a guide file creator for creating the guide file using the contents stored in the storage section.

### TECHNICAL FIELD

The present invention relates to a program for creating a user manual or guiding program which uses a graphical user interface (GUI) to help users operate an application program.

### BACKGROUND ART

Computers allow users to perform a wide variety of tasks using various programs. However, as the number of such programs increases, the number of operations which are specific to each individual program also increases, making it difficult for users to correctly memorize and perform all operations. Accordingly, programs are often provided with a printed or an electronic manual which can be viewed or played on personal computers, in order to help users correctly operate the program or to introduce various functions which the program possesses. Electronic manuals allow the use of links for jumping to the related topics as well as the embedding of animated objects, so users can easily and intuitively understand various operations. Furthermore, electronic manuals can be created and distributed at low costs. Therefore, in recent years, electronic manuals have been more commonly used than the printed versions.

In recent years, analyzers as well as many other industrial devices have been frequently operated by a control system configured by installing a dedicated program on a multipurpose computer. The reason for this is because such a system does not only facilitate the operations but also allows the control data, measurement data and other related information to be used in other programs (application programs). The dedicated program used in such a control system for controlling the target device (e.g. analyzer) or analyzing the thereby obtained measurement data is a highly special program whose operations are difficult for users to correctly memorize. Incorrect operations will incur inconvenient situations; e.g. the analysis (or other tasks) may be prevented, or incorrect data may be obtained. For such dedicated programs, it is essential to teach users correct operations. Accordingly, it is necessary to prepare detailed manuals.

Normally, an electronic manual is designed to be viewed separately from the program for which the manual is provided (“target program”). The inventor has proposed a program for assisting user operation on a target program. While the target program is running, the assisting program automatically identifies the GUI component which is being operated by the user (such a component is hereinafter called the “target of operation” or “operation target”) and superposes guidance or similar information on the window of the target program without interfering with the display in this window (see Patent Literature 1; such a program is hereinafter called the “operation navigation program” or “operation navigator”). The program shows appropriate guidance information related to the demanded operation while the target program is running. Such a navigation program allows users to more easily understand the operation and is more effective for preventing incorrect operations than electronic manuals.

### CITATION LIST

### Patent Literature

Patent Literature 1: JP 2015-035120 A

### SUMMARY OF INVENTION

### Technical Problem

The conventional electronic manuals and operation navigator are useful for users. However, each of them needs to be previously created. For example, an electric manual is created as follows: While the target program is running, the creator actually performs various operations on the target program, captures a portion or the entirety of the window image (“content”) in each important step of the operation, and temporarily stores the captured contents. After all necessary contents are completed, the creator arranges those contents according to the operation procedure which users are expected to execute. Additionally, the creator needs to add appropriate graphic guides (e.g. arrows or circles) and notes (e.g. comments) to each window image. In the case of the operation navigator, the creator needs to create frames and other graphic guides to be superposed on the display of the target program in each operation step as well as add appropriate text or graphic information for guiding users through the operation.

Such a manual or operation navigator is normally prepared by the developer of the target program, although in some cases it is created by end users or similar individuals who are not directly involved in the development. When the target program is running and being operated, it is possible to add appropriate graphic guides and comments for the assumed users. However, in the process of arranging and editing the temporarily stored contents, the task of adding appropriate graphic guides and comments is difficult, since the creator's attention is inevitably diverted from the target program. This problem is particularly noticeable when non-developers perform the task. Although a dedicated program for automatically arranging the contents is available, the creator still needs to perform considerably burdensome tasks (such as reediting the comments) to make the contents easy to understand for end users.

The problem to be solved by the present invention is to provide a program for easily creating an electronic manual or operation navigation program which users can easily understand (such manuals and programs are hereinafter collectively called the “guide file”).

### Solution to Problem

The present invention developed for solving the previously described problem is a program for creating a guide file for guiding a target-program operator who operates a target program while the target program is running, the program making a computer function as:

a) an operation target detector for detecting, at a predetermined timing, a target of operation performed on the display window of the target program by a creator operating the target program:

b) a graphic guide displayer for displaying, in the vicinity of the target of operation, a graphic guide which is a graphic object for drawing attention of the target-program operator to the target of operation;

c) a text guide displayer for displaying a preset guiding text related to the target of operation and/or an input field for allowing the creator to type in text;

d) a contents storage processor for storing, into a designated storage section, the target of operation, the graphic guide, as well as the guiding text and/or the text typed in the input field by the creator; and

e) a guide file creator for creating the guide file using the contents stored in the storage section.

The “creator” is a person who creates a guide file for a target program using the program according to the present invention. The guide file created in this manner is offered for the sake of the “target-program operator”, i.e. anyone who uses (operates) the target program.

The predetermined timing for the operation target detector to detect the target of operation may be set at predetermined intervals of time, or it may be a point in time where a specific operation is performed by the creator. In the former case, the interval of time is preferred to be within a range from 0.5 to 1.0 seconds; for example, the detection of the target of operation may be performed at intervals of 0.5 seconds. In the latter case, the detection of the target of operation is triggered by a specific event, e.g. the pressing of the Ctrl-key on the keyboard by the creator.

One possible method for detecting the target of operation is to use image processing. For example, many application programs are designed to produce a visual change on the displayed image, such as highlighting, of the component which the mouse cursor being moved by the operator (creator) is placed on or approaching to. The operation target detector can detect such a change in the image due to the operation by the operator (creator) by an appropriate image processing technique (e.g. by computing the difference between two images obtained before and after that change). The detected area is selected as a candidate of the target of operation. Another possible method, which does not rely on the image processing, is to use an application programming interface (API) or similar functions offered by the operating system (OS). For example. Windows® OS has the API which enables application programs to locate the position of the control (widget) on which the focus (mouse cursor) is set. The operation target detector can select the candidate of the target of operation based on the detection result.

With regards to these two methods for detecting the target of operation, the creator may previously specify which of them should be used. It is also possible to simultaneously use both methods.

Additionally, the operation target detector may select the target of operation from the aforementioned candidates of the target of operation. If only one candidate of the target of operation has been detected, the candidate is immediately selected as the target of operation. If a plurality of candidates of the target of operation have been simultaneously detected, the operation target detector may select all detected candidates as the targets of operation, or alternatively, it may set priorities to the individual candidates and select one or more candidates having high priorities as the targets of operation.

The graphic guide displayer shows a graphic guide in the vicinity of the detected target of operation. The graphic guide should preferably be displayed in a superposed form on, or in the vicinity of the display window of the target program, although in some cases it may be placed at a separated position. Examples of the shape of the graphic guide include a triangular frame, circular frame and other frame forms, as well as a figure which matches with the shape of the target of operation. When superposed on the target of operation, the graphic guide should preferably be given a translucent appearance.

The text guide displayer shows, near the graphic guide, a preset guiding text related to the target of operation and/or an input field for allowing the creator to type in text (such a guiding text and input field are hereinafter collectively called the “text guides”). The input field allows the creator to type in an instruction or comment, such as the content of the operation to be performed on the target of operation or the matters that require attention during the operation.

The contents storage processor stores, into the storage section, the contents data. i.e. the target of operation, graphic guide, and text guide created by the previously described functional components. The data-storing action may be executed when a specific operation for the data-storing action is performed by the creator using a keyboard or other devices, or it may be executed when the creator has completed the typing of the text in the input field or has performed the predetermined operation on the target of operation. In the latter case, the contents data created on the currently displayed window by the creator are automatically stored simultaneously with the transition of the target program to the next display window (i.e. to the next operation step).

By repeating the contents-storing process, a plurality of sets of data related to the contents (images of the display window of the target program, the content of the operation, etc.) are sequentially collected in the storage section. A captured image taken at each step is also stored and collected in the storage section.

Using the contents stored in the storage section as the materials, the guide file creator compiles a guide file, such as an electronic manual, video manual, or data for the operation navigation program. Since appropriate graphic and text guides are added to the contents used in the compilation of the guide file, an easy-to-understand guide file can be obtained. Furthermore, since the contents are stored in order of the operation steps, an easy-to-understand guide file can be obtained by a simple method, e.g. by automatically sorting those contents in time-series order.

The previously described program for creating a guide file may further include

f) a graphic guide editor for changing the position and/or shape of the graphic guide.

According to this configuration, the creator can freely change the position and/or shape of the graphic guide. Therefore, if the target of operation detected by the operation target detector does not agree with the position and/or size intended by the creator, the creator can modify the position and/or shape of the graphic guide as needed.

### Advantageous Effects of the Invention

With the guide file creation program according to the present invention, the creator can create and place explanatory text and other contents at the very point in time where the creator is operating the target program. Therefore, it is easy to add appropriate graphic guides and comments. Using the contents with those graphic guides and comments added, the creator can easily create a guide file that is easy to understand for operators.

### BRIEF DESCRIPTION OF DRAWINGS

FIG. 1 is a schematic configuration diagram of an analyzing system in which a guide file creation program as one embodiment of the present invention operates.

FIG. 2 is a flowchart of the operation of the guide file creation program according to the present embodiment.

FIGS. 3A and 3B are examples of the execution windows of the guide file creation program, where FIG. 3A is the window for creating the contents, and FIG. 3B is the dialog for selecting the data format.

FIGS. 4A and 4B are examples of the display window of an analyzer control program, where FIG. 4A is an example with no portion highlighted, and FIG. 4B is an example with one item in the menu bar highlighted.

FIG. 5 is one example of the execution window of the analyzer control program on which a graphic guide in the present embodiment is superposed.

FIG. 6 is one example of the execution window on which a graphic guide in the present embodiment is resized.

FIGS. 7A-7C are examples of the image data to be stored in the storage section in the present embodiment, where FIG. 7A is the captured image A. FIG. 7B is the captured image B and FIG. 7C is the completed window image.

FIG. 8 is one example of the execution window on which a plurality of graphic guides according to the present embodiment are displayed.

FIG. 9 is one example of an image stored as the captured image A which shows only a portion of the graphic guide according to the present embodiment.

### DESCRIPTION OF EMBODIMENTS

One embodiment of the guide file creation program according to the present invention is hereinafter described in detail with reference to the drawings.

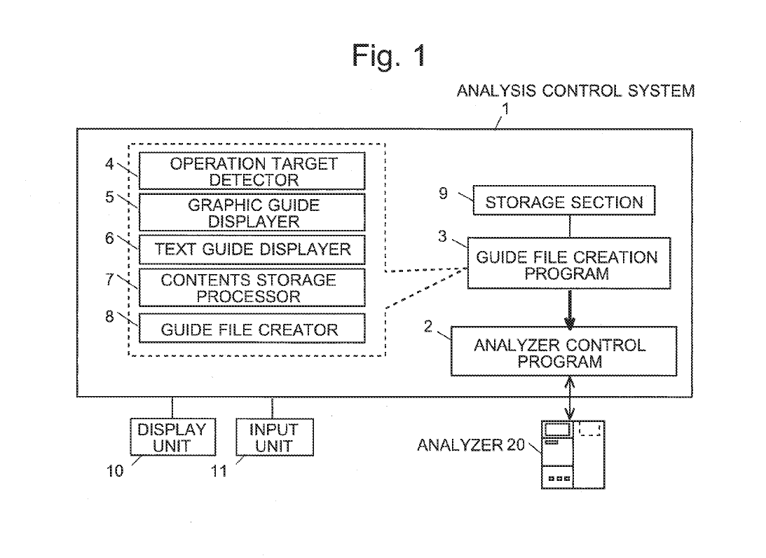

FIG. 1 is a schematic configuration diagram of an analyzing system in which a guide file creation program as one embodiment of the present invention operates.

The present analyzing system includes an analysis control system 1 connected to an analyzer 20 (e.g. a liquid chromatograph). The analysis control system 1 has the function of controlling the operation of the analyzer 20 and analyzing the result of a measurement performed in the analyzer 20.

The analysis control system 1 is actually a multipurpose personal computer (PC) including a central processing unit (CPU), memory unit, and mass storage device, such as a hard disk drive (HDD) or solid state drive (SSD). A portion of the mass storage device is used as the storage section 9 for storing the data created by the guide file creation program 3. In this analysis control system 1, an analyzer control program 2 (which corresponds to the target program in the present invention) is executed on the operating system (OS), e.g. Windows® operating system.

Connected to the analysis control system 1 is a display unit 10 (e.g. a liquid crystal display) for displaying various kinds of information and an input unit 11 including a mouse, keyboard and other input devices for allowing users to enter various commands. Although the display unit 10 and input unit 11 in FIG. 1 are located outside the analysis control system 1, these units 10 and 11 may be built-in components of the analysis control system 1, as in the case where the analysis control system 1 is constructed using a tablet computer.

The guide file creation program 3 operates in the analysis control system 1 (i.e. the program is installed on the PC).

The configuration of the guide file creation program 3 is hereinafter described. The guide file creation program 3 includes an operation target detector 4, graphic guide displayer 5, text guide displayer 6, contents storage processor 7, and guide file creator 8. All of them are realized in the form of software components on the PC of the analysis control system 1.

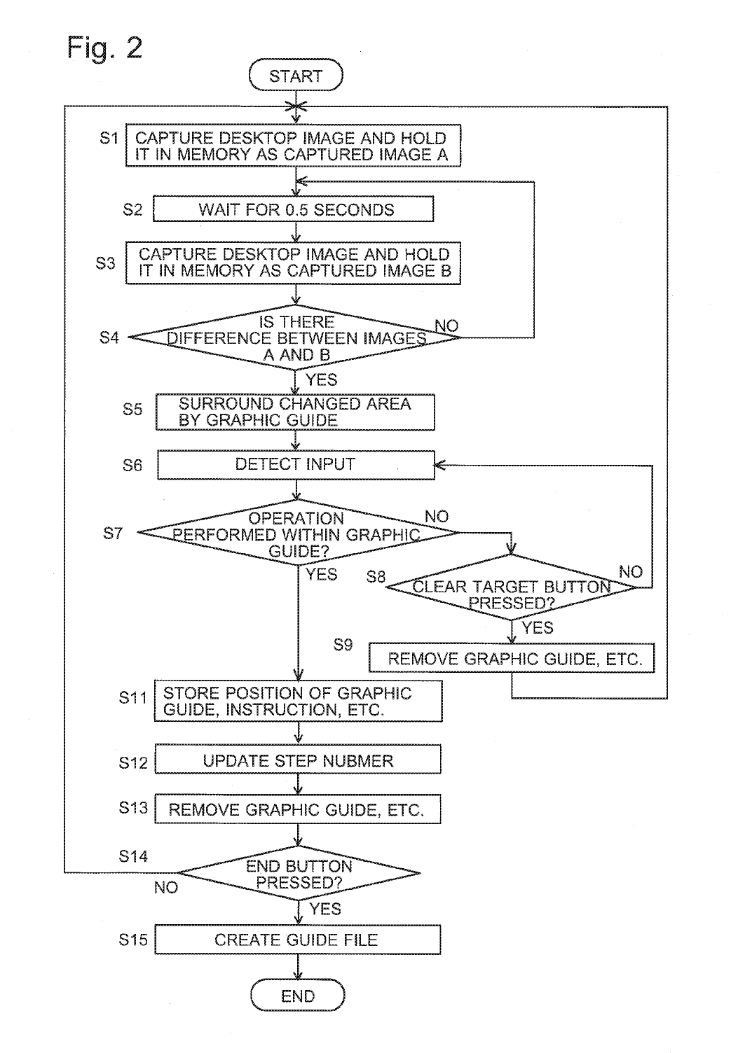

The operation of the guide file creation program 3 is hereinafter described with reference to the flowchart shown in FIG. 2.

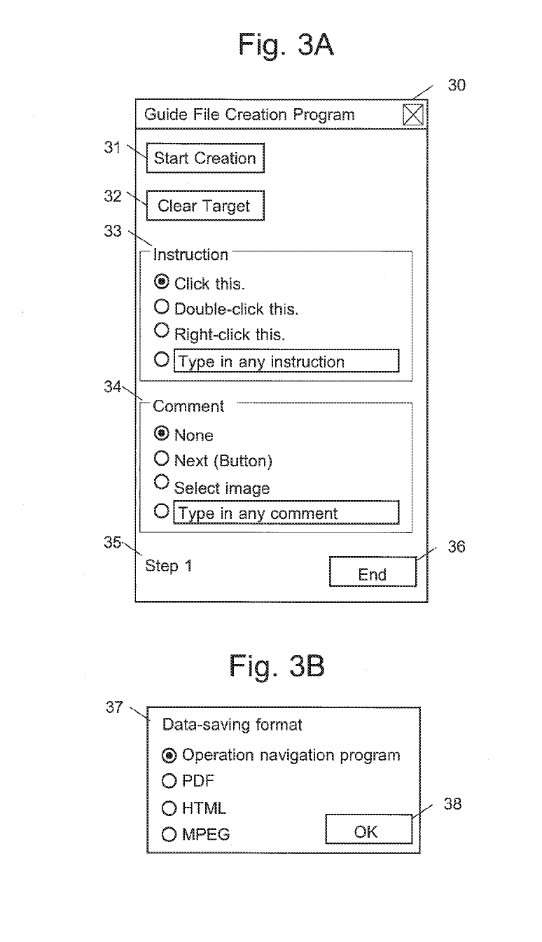

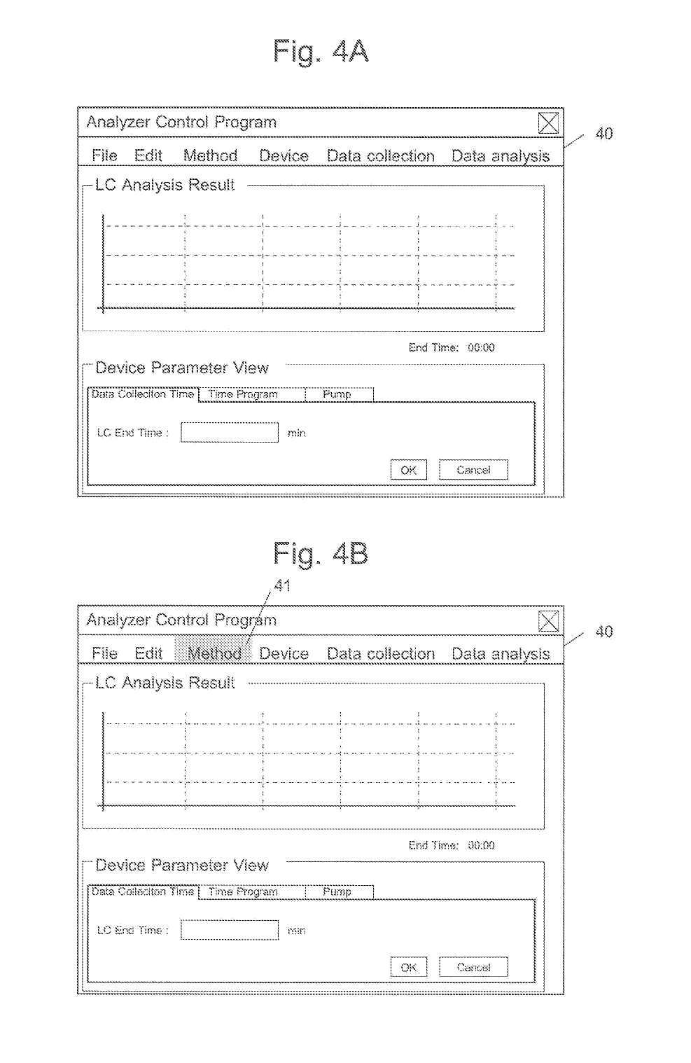

When the guide file creation program 3 and the analyzer control program 2 are executed, the execution windows as shown in FIGS. 3A and 4A are respectively displayed.

When the start creation button 31 on the guide file creation program 3 is pressed by the creator, the operation target detector 4 captures a desktop image including the control execution window 40 of the analysis control program 2 (e.g. an image as shown in FIG. 4A is captured) and holds it in the memory unit as the captured image A (Step S1). Such a capturing process is similarly and automatically repeated at intervals of 0.5 seconds (Step S2), and the captured desktop image is held in the memory unit as the captured image B (Step S3). The operation target detector 4 performs the predetermined image processing, such as the computation of the difference in the luminance of the corresponding pixels between the captured images A and B, to detect any portion in the captured image B which has changed from the captured image A. While there is no difference between the two images (“NO” in Step S4), the operation target detector 4 repeats the process of Steps S2, S3 and S4.

Now, suppose that the creator has moved the cursor over the “Method” menu on the control execution window 40. Due to a function of the analyzer control program 2, the area around the character string “Method” is highlighted (FIG. 4B). When an image of this control execution window 40 is captured as image B, the operation target detector 4 locates the area which has changed from the previously captured image A. i.e. the highlighted area 41 (“YES” in Step S4).

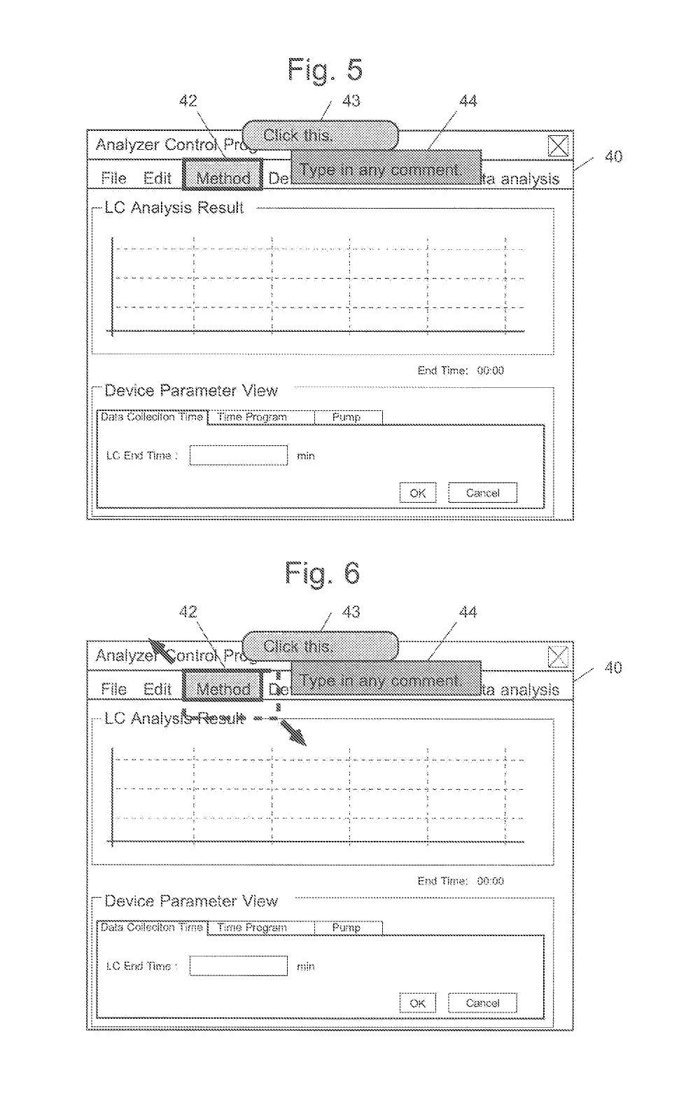

The graphic guide displayer 5 shows a graphic guide 42 (FIG. 5), which is a rectangular frame that entirely surrounds the detected area (“surrounded area”), in the vicinity of the highlighted area on the control execution window 40 (Step S5). The graphic guide 42 does not always need to have a rectangular shape: it may be a circle, ellipse, polygon or any other figure which makes the surrounded area noticeable for the creator. Additionally, the graphic guide 42 may be configured so that its frame can be resized by dragging one of its sides or corners with the mouse (FIG. 6). It is also possible to provide the function of adding a corner to the frame of the graphic guide 42 by clicking one of its sides with the SHIFT-key down. The graphic guide 42 does not always need to be a frame. For example, it may be an image showing the surrounded area in a different display color or an image showing the surrounded area with a prepared image mask applied. These images can also be superposed as the graphic guide 42 on the control execution window 40. In other words, those images should also be regarded as one type of the graphic object in the present invention.

At the same time as the graphic guide 42 is displayed, the text guide displayer 6 superposes an instruction display object 43 and comment display object 44 as shown in FIG. 5 (each of which corresponds to the text guide in the present invention) on the control execution window 40. These objects should preferably be positioned near the graphic guide 42, as in FIG. 5. It is also possible to provide the function of allowing the creator to change the display position and size of the instruction display object 43 or comment display object 44 by dragging the object. Making their display position and size changeable makes it possible to prevent the GUI components and information on the control execution window 40 from being hidden by the instruction display object 43 or comment display object 44.

The contents displayed in the instruction display object 43 and the comment display object 44 depend on the items respectively specified in the instruction input field 33 and the comment input field 34 by the creator. In the present embodiment, as one example of the display of the instruction input field 33, three text strings are predefined: “Click this”, “Double-click this” and “Right-click this”. The creator can change the display of the instruction display object 43 by selecting one of these options. The “type in any instruction” field allows the creator to type in any text string and make it displayed in the instruction display object 43. In the comment input field 34, if “None” is chosen, the comment display object 44 is removed. If “Select image” is chosen, the text guide displayer 6 shows a window for allowing the creator to select one of the image data previously stored in the mass storage device of the analysis control system 1. The thereby selected image is displayed in the comment display object 44. The “Next (Button)” option is only used for the operation navigation program. When a piece of data including this item is used in the operation navigation program, the comment display object 44 is displayed in the form of a button labeled “Next”. When this button is pressed, the next operation step is displayed. (The operation navigation program proceeds to the next step when a specific mouse operation is performed at the operation target or when the “Next” button is pressed.)

Additionally, the creator can also click the instruction display object 43 or the comment display object 44 and directly type in the instruction or comment.

While the graphic guide 42, instruction display object 43 and comment display object 44 are displayed on the window 40 of the target program, the guide file creation program 3 detects each operation performed by the creator (Step S6) and determines whether or not the operation has been performed within the graphic guide 42 (Step S7). If the result in Step S7 is “NO”, the guide file creation program 3 determines whether or not the operation is the pressing of the clear target button 32 (Step S8). If the result in Step S8 is “YES”, the graphic guide displayer 5 removes the graphic guide 42, while the text guide displayer 6 removes the instruction display object 43 and the comment display object 44 (Step S9), and once more performs the process from Step S1. For example, when the graphic guide 42 has been displayed at an unintended position, the creator can click the clear target button 32 to once more perform the display of the graphic guide 42 and the related processes.

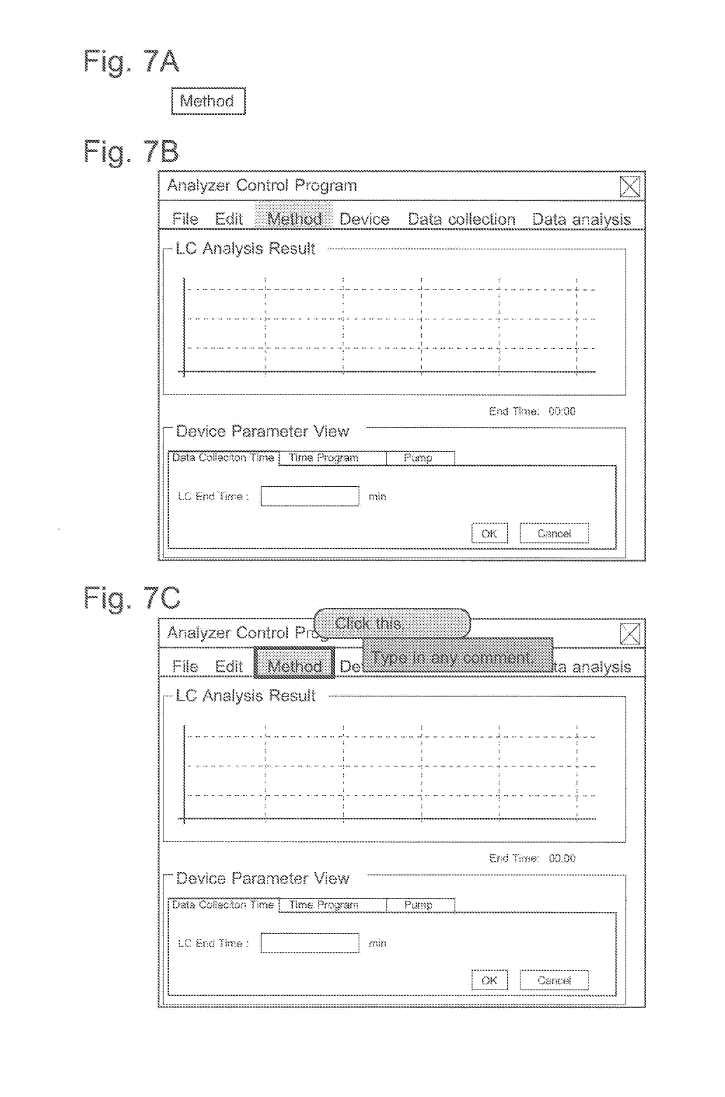

If a certain operation (e.g. clicking) is performed within the graphic guide 42 by the creator (“YES” in Step S7), the contents storage processor 7 stores the captured images and related contents in the storage section 9 (Step S11). In this process, the following contents are stored: an image of the operation target clipped from the captured image A (FIG. 7A); an image including the area surrounded by the graphic guide 42 (e.g. the entire window including the operation target) clipped from the captured image B (FIG. 7B); the position (in relative coordinates to the operation target in FIG. 7A) and shape of the graphic guide; the text string (or if an image is selected, the image) and the display position (in relative coordinates to the graphic guide 42) of the instruction text and comment text: the content of the operation performed within the graphic guide 42 in Step S6 (single-click, double-click, etc.); the position where the operation was performed (in relative coordinates to the graphic guide 42); and the completed window image with the graphic guide 42, instruction text, selected image, and other contents arranged on it (FIG. 7C).

The completed window image can be produced from the data stored in the storage section 9 (exclusive of the completed window image) by superposing images, text strings and other contents on the original window image. Alternatively, a desktop image in Step S6 may be captured and stored as the completed window image.

After the previously described storing process is completed, the display of the step number indicator 35 in FIG. 3A is changed to the number which is equal to one plus the number of previously performed storing processes (Step S12). For example, after the first storing process is completed, the step number indicator 35 changes to “Step 2”.

After the process of Step S12 is completed, the graphic guide displayer 5 removes the graphic guide 42 from the window, while the text guide displayer 6 removes the instruction display object 43 and the comment display object 44 (Step S13). Subsequently, the guide file creation program 3 once more performs the process from Step S1.

The clicking operation performed within the graphic guide by the creator in Step S6 is an operation performed on the analyzer control program 2. Therefore, the analyzer control program 2 actually carries out the process and screen display which are programmed to be performed when the “Method” menu is clicked. Accordingly, on the display window on which the “Method” menu has been clicked, the creator can immediately perform the task of creating the data for the next operation step.

In this manner, by repeating the task of setting the graphic guide, instruction text and other contents using the guide file creation program 3, the creator can record the operation steps while actually operating the analyzer control program 2. The thereby produced data are sequentially stored in the storage section 9 in order of the operation steps.

After all operation steps have been recorded, or at an arbitrary timing, the creator presses the end button 36 (“YES” in Step S14). Then, the guide file creation program 3 displays the data format selection dialog 37 as shown in FIG. 3B. The creator selects the data format and presses the OK button 38, whereupon the guide file creator 8 converts the data stored in the storage section 9 into the data format specified by the creator (Step S15). In the present embodiment, the data formats include the PDF, HTML and MPEG formats for electronic manuals. For example, when one of these data formats is selected, the completed screen images on which the graphic guides, explanatory text, images and other contents are placed at the specified positions are compiled into an electronic manual which sequentially shows those screen images in order of the operation steps. It is also possible to allow the creator to manually create the guide file by arranging those images in arbitrary order and reediting the comments and other contents as needed. The data format is not limited to the aforementioned ones; the guide file can be created in various document formats or video formats.

The contents stored by the contents storage processor 7 can also be used in the operation navigation program. Patent Literature 1 (paragraph [0022]) shows a list of data necessary for displaying an additional GUI component in the operation navigation program. The “reference image” in that list corresponds to the “image of the operation target clipped from the captured image A” in the present embodiment, the “image of additional GUI component” corresponds to the “graphic guide”, the “information on the display position designated for the additional GUI component” corresponds to the “position of the graphic guide”, and the “operation to be performed for the measurement device control software” corresponds to the “content of the operation performed within the graphic guide”. The operation navigation program can read these data and display a guide file (or play a navigation) using the read data.

The previously listed data are mere examples of the data to be stored. It is possible to appropriately change the kinds of stored image data and text data according to the formats of the data required by the operation navigation program.

It should be noted that the previously described embodiment of the guide file creation program according to the present invention can be appropriately changed or modified within the spirit of the present invention.

In the previous embodiment, it is assumed that the program automatically captures the images A and B. It is also possible to allow the creator to specify the timing of the capturing. In this case, for example, when the pressing of a specific key (e.g. the Ctrl-key on the keyboard) by the creator is detected, the graphic guide displayer 5 captures the desktop image and stores it as image A. Subsequently, when the pressing of the specific key is once more detected, the graphic guide displayer 5 once more captures the desktop image and stores it as image B. After that, every time the specific key is pressed, the graphic guide displayer 5 replaces the captured image B with the new one. According to this configuration, the creator can obtain the desktop images at appropriate timings and thereby prevents the graphic guide 42 from being displayed at an unintended position due to an incorrect operation or otherwise.

In Step S4 of the previous embodiment, the operation target is located by detecting a difference between the captured images A and B. It is also possible to locate the operation target through the API or similar functions offered by the OS. For example, the Windows® OS has the API which allows application programs to obtain the position coordinate information of the control (widget) which is pointed by the mouse cursor (i.e. which is focused). Based on this information, the operation target detector 4 can display the graphic guide 42 around the control.

In the previous embodiment, the entire desktop image is captured as images A and B. It is also possible to use a partial desktop image. As already explained, the highlighting of a button (operation target) mostly occurs within a certain area around the mouse cursor. Accordingly, it is possible to define a certain area with an appropriate number of pixels around the mouse cursor, capture the desktop image within that area, and store it as the captured image A or B. This method decreases the size of the image to be captured and processed for the detection of the operation target, and consequently reduces the processing load on the analysis control system 1. Furthermore, if an unintended change in the screen display occurs at a position far from the mouse cursor, the change will not be detected, and therefore, the graphic guide will not be displayed at the incorrect position.

The system may also be configured so that, when two or more areas each of which corresponds to one GUI component have been detected by the method based on the change in the captured image or using the API, priorities are set to those areas, and the one which has the highest priority is selected as the operation target. One method for the prioritization is to display the graphic guide at the surrounded area which is the closest to the mouse cursor. Another method is to only display the graphic guide at the surrounded area located within a certain distance from the mouse cursor. By these methods, the GUI component which the creator is about to operate can be prioritized as the operation target.

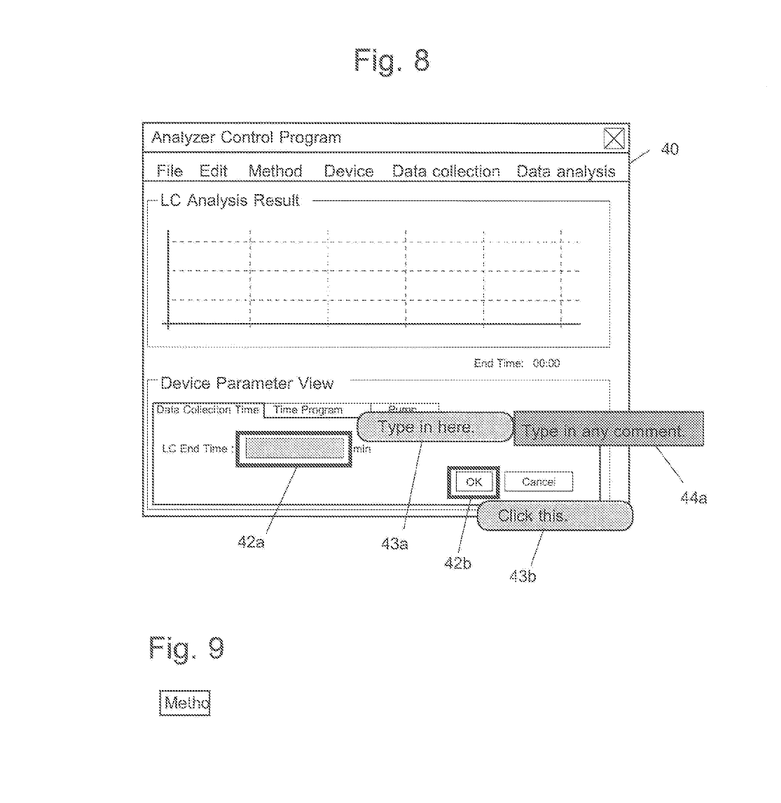

It is also possible to select two or more areas from among the detected areas with high priorities as the operation targets and display the graphic guide for each operation target. FIG. 8 shows one example, in which an input field and a corresponding button are respectively surrounded by the graphic guides 42a and 42b so that the attention of the operator using the target program will be directed to both components.

In the previous embodiment, one instruction display object 43 and one comment display object 44 are displayed. It is possible to display two or more such objects. For this purpose, a button for adding the instruction text and/or one for adding the comment text can be provided in the execution window (creation assistance window) 30 of the guide file creation program 3 so as to allow two or more instruction text strings and/or comment text strings to be displayed in the same step, as denoted by numerals 43a, 43b and 44a in FIG. 8.

Conversely, it is also possible to create a display which has neither the instruction display object 43 nor the comment display object 44. By providing the instruction input field 33 with the “None” option as in the comment input field 34, the instruction text and the comment text can both be removed from the display.

As one method for setting the text string in the instruction input field 33 and the comment input field 34 different from the previously described input method, the character information read from the image within the surrounded area by the technique of the optical character reader (OCR) can be automatically set in the input field. For example, in the previous embodiment, the character string “Method” can be extracted from the image data (within the range of the captured image A surrounded by the graphic guide) by the OCR and combined with a prepared character string to form a sentence to be displayed, e.g. “Click Method”.

As another input method, the graphic guide displayer 5 may identify the type of operation performed inside the frame of the graphic guide 42 by the creator, and the text guide displayer 6 may automatically set the instruction text including the identified type of operation. For example, when the creator has clicked the area inside the frame of the graphic guide in Step S6, the graphic guide displayer 5 detects the clicking operation through the API (or otherwise), and the text guide displayer 6 sets “Click this” as the instruction text.

In Step S1, the image of the operation target clipped from the captured image A (which is hereinafter called the “in-guide image A”) is stored in the storage section. The image data stored in this process may be only a portion of the in-guide image A.

The operation navigation program described in Patent Literature 1 refers to the reference image (in-guide image A) and locates the image corresponding to the reference image within the desktop image on which the target program and other programs are displayed. For the detection of the image, various detection techniques are available, such as the image matching or pattern recognition. If the reference image has a large size, the detection process incurs a considerable amount of load and causes various problems, such as the decrease in the operation speed. Additionally, in the case where the reference image (in-guide image A) includes an unnecessary portion around the operation target, it will be impossible to detect the same image as the reference image (in-guide image A) if the aforementioned unnecessary portion is changed for some reasons, such as a change in the screen layout of the target program.

By reducing the size of the reference image (in-guide image A) as shown in FIG. 9 under the condition that the image is recognizable as the target in the detection process by the operation navigation program, it is possible to decrease the image processing load and increase the operation speed as well as make the detection process unsusceptible to a change in the screen layout of the target program. Additionally, the amount of image data stored in the storage section 9 is also decreased.

The contents stored in the storage section 9 are not limited to the data formats described in the previous embodiment. For example, the data of the graphic guide may be a piece of raster image data or a piece of vector data for drawing a rectangle, circle or any other figure. In the case of performing a process using an image mask, the data of the image mask may be stored as the data of the graphic guide.

In the previous embodiment, the guide file creation program 3 is operated by clicking the buttons on the creation assistance window 30. It is possible to assign those operations to the keys on the keyboard. This produces the effects of eliminating the time for moving the mouse cursor for the operation as well as allowing the creation assistance window 30 to be accessed using the keyboard even when this window is hidden behind the control execution window 40 or minimized in the task bar.

### REFERENCE SIGNS LIST

1 . . . Analysis Control System
2 . . . Analyzer Control Program
3 . . . Guide File Creation Program
4 . . . Operation Target Detector
5 . . . Graphic Guide Displayer
6 . . . Text Guide Displayer
7 . . . Contents Storage Processor
8 . . . Guide File Creator
9 . . . Storage Section
10 . . . Display Unit
11 . . . Input Unit
20 . . . Analyzer
30 . . . Creation Assistance Window
31 . . . Start Creation Button
32 . . . Clear Target Button
33 . . . Instruction Input Field
34 . . . Comment Input Field
35 . . . Step Number Indicator
36 . . . End Button
37 . . . Data Format Selection Dialog
38 . . . OK Button
40 . . . Control Execution Window
41 . . . Highlighted Area
42 . . . Graphic Guide
43 . . . Instruction Display Object
44 . . . Comment Display Object

1. A non-transitory computer readable medium recording a program for creating a guide file for guiding a target-program operator who operates a target program while the target program is running, wherein the program makes a computer function as:
a) an operation target detector for detecting, at a predetermined timing, a target of operation performed on a display window of the target program by a creator operating the target program;
b) a graphic guide displayer for displaying, in a vicinity of the target of operation, a graphic guide which is a graphic object for drawing attention of the target-program operator to the target of operation;
c) a text guide displayer for displaying a preset guiding text related to the target of operation and/or an input field for allowing the creator to type in text;
d) a contents storage processor for storing, into a designated storage section, the target of operation, the graphic guide, as well as the guiding text and/or the text typed in the input field by the creator; and
e) a guide file creator for creating the guide file using contents stored in the storage section.

2. The medium according to claim 1, wherein the program further makes the computer operate as:
f) a graphic guide editor for changing a position or shape of the graphic guide.
